(19) United States
(12) Patent Application Publication
(10) Pub. No.: US 2025/0245352 A1
(43) Pub. Date: Jul. 31, 2025

(54) MULTIMODAL SEMANTIC SENSOR DATA FINGERPRINTING

(71) Applicant: Dell Products L.P., Round Rock, TX (US)

(72) Inventors: Maxwell S. Andrews, Kennett Square, PA (US); Charles D. Robison, Buford, GA (US)

(73) Assignee: Dell Products L.P., Round Rock, TX (US)

(21) Appl. No.: 18/424,229

(22) Filed: Jan. 26, 2024

(51) Int. Cl. G06F 21/60

(52) U.S. Cl. CPC G06F 21/602

(57) ABSTRACT

An information handling system may receive, from a first sensor of the information handling system, content to be associated with a semantic cryptographic fingerprint. The first information handling system may also receive, from the first sensor context data contains information about time and date, geolocation coordinates, metadata, etc. Based, at least in part, on the semantic cryptographic fingerprint and the context data, the information handling system may determine a cryptographic tag. The information handling system may sign the cryptographic hash with a private key. Finally, the information handling system may then publish the cryptographic hash with an indicator of the content to a public database or directory.

### FIELD OF THE DISCLOSURE

The present disclosure generally relates to information handling systems, and more particularly relates to information handling system security.

### BACKGROUND

As the value and use of information increases, individuals and businesses seek additional ways to process and store information. One option is an information handling system. An information handling system generally processes, compiles, stores, and/or communicates information or data for business, personal, or other purposes. Because technology and information handling needs may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

One increasingly popular use for information handling systems is reviewing current event content captured as images, video, and audio. Information handling systems can be used to execute a variety of information reporting applications such as social media and news applications. Information reporting applications may range in coverage from the user's local neighborhood to international events.

As users increasingly gain awareness of the events of the day from their social media and news applications, there is an increasing concern that such information may be determined to be AI-generated. Relying on second and third reports to verify the genuineness of the social media post can be time consuming and inefficient.

Shortcomings mentioned here are only representative and are included simply to highlight that a need exists for improved verification of information. Embodiments described herein address certain shortcomings but not necessarily each and every one described here or known in the art. Furthermore, embodiments described herein may present other benefits than, and be used in other applications than, those of the shortcomings described above.

### SUMMARY

### I. General Disclosures

The present disclosure is directed to a method and system for creating multimodal semantic sensor data fingerprinting. In some embodiments, a robust verification means may provide users desiring assistance with determining if the digital content, which may include photos, audio/video, social media, blog, news post, were not AI-generated; thereby, ensuring that only non-AI-generated data may be presented on the application. Some non-limiting examples include video and audio produced for the social media application on an information handling system of the user, such as a smart phone, personal computer, or laptop, may be found to be AI-generated may not displayed on the information handling system. Using the disclosed system or method, users may ensure that the information displayed to them on their information handling systems through their digital information applications is not AI-generated. Such reliability may enhance a user experience by giving peace of mind that the content the user is reviewing is not AI-generated.

### II. Methods of the Disclosure

The present disclosure is directed to a method for creating multimodal semantic sensor data fingerprinting. In some embodiments, first sensor of a first information handling system receives content to be associated with a semantic cryptographic fingerprint. In some embodiments, the first sensor may comprise a camera, a microphone, or another measuring device. In some embodiments, the sensor data is signed with a private key of the sensor.

In some embodiments, the first information handling system determines the semantic cryptographic fingerprint of the digital content. In some embodiments, the semantic cryptographic fingerprint is nonreversible. In some embodiments, the first information handling system creates the semantic cryptographic fingerprint before storing the file in a user-accessible region of memory. In some embodiments, a fingerprint algorithm comprises applying a series of statistical modeling processes comprising convolutional filter kernels, moving averages, cross-correlation, auto-correlation, spatial filtering in image processing, kernel density estimation, spatial autoregressive models, and wavelet transforms to create the semantic cryptographic fingerprint, to create the semantic cryptographic fingerprint.

In some embodiments, the first information handling system receives a system context of the first information handling system at the time of creation of the digital content. In some embodiments, the system context comprises a sensor measurement date, timing, a geolocation coordinate, metadata, private key of the sensor.

In some embodiments, the first information handling system determines a hash of the semantic cryptographic fingerprint and the system context.

In some embodiments, the first information handling system sends to a second information handling system the hash with an indicator associating the content from which the hash was determined from. In some embodiments, the hash, associated with a private key, is uploaded to a public database with an associated public key.

In some embodiments, the first or a third information handling system, sends an instruction to an application present on the first or third information handling system that limits access to the content to a set of users based on the hash of the content.

### III. Systems of the Disclosure

The present disclosure is directed to a system for creating multimodal semantic sensor data fingerprinting. In some embodiments, first sensor of a first information handling system receives content to be associated with a semantic cryptographic fingerprint. In some embodiments, the first sensor may comprise a camera, a microphone, or another measuring device. In some embodiments, the sensor data is signed with a private key of the sensor.

In some embodiments, the first information handling system determines the semantic cryptographic fingerprint of the digital content. In some embodiments, the semantic cryptographic fingerprint is nonreversible. In some embodiments, the first information handling system creates the semantic cryptographic fingerprint before storing the file in a user-accessible region of memory.

In some embodiments, a fingerprint algorithm comprises applying a series of statistical modeling processes comprising convolutional filter kernels, moving averages, cross-correlation, auto-correlation, spatial filtering in image processing, kernel density estimation, spatial autoregressive models, and wavelet transforms to create the semantic cryptographic fingerprint,

In some embodiments, the first information handling system receives a system context of the first information handling system at the time of creation of the digital content. In some embodiments, the system context comprises a sensor measurement date, timing, a geolocation coordinate, metadata, private key of the sensor.

In some embodiments, the first information handling system determines a hash of the semantic cryptographic fingerprint and the system context.

In some embodiments, the first information handling system sends to a second information handling system the hash with an indicator associating the content from which the hash was determined from. In some embodiments, the hash, associated with a private key, is uploaded to a public database with an associated public key.

In some embodiments, the first or a third information handling system, sends an instruction to an application present on the first or third information handling system that limits access to the content to a set of users based on the hash of the content.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a diagram of an example of a first, second, third information handling system as well as a sensor according to some embodiments of the disclosure.

FIG. 2 is a block diagram of one embodiment of a multimodal semantic sensor data fingerprinting data processing according to some embodiments of the disclosure.

FIG. 3 is a block diagram of an example method for creating the hashtag according to some embodiments of the disclosure.

FIG. 4 is a block diagram of an example method for creating the semantic cryptographic fingerprint according to some embodiments of the disclosure.

FIG. 5 is a general diagram of an example method for creating the hashtag according to some embodiments of the disclosure.

FIG. 6 is a block diagram of an example method for content fingerprint verification according to some embodiments of the disclosure.

FIG. 7 is a schematic block diagram of an example information handling system according to some embodiments of the disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

### I. Example Description of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

Throughout this specification, unless the context requires otherwise, the words “comprise”, “comprises” and “comprising” will be understood to imply the inclusion of a stated step or element or group of steps or elements but not the exclusion of any other step or element or group of steps or elements. Further, the words “comprising” (and any form of comprising, such as “comprise” and “comprises”), “having” (and any form of having, such as “have” and “has”), “including” (and any form of including, such as “includes” and “include”), “characterized by” (and any form of including, such as “characterized as”), or “containing” (and any form of containing, such as “contains” and “contain”) are inclusive or open-ended and do not exclude additional, unrecited elements or method steps. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

Reference throughout this specification to “one embodiment,” “an embodiment,” “some embodiments,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present embodiment. Thus, the appearances of the foregoing phrases in various places throughout this specification are not necessarily all referring to the same embodiment. Furthermore, the particular features, structures, or characteristics may be combined in any suitable manner In some embodiments.

### II. General Embodiments

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (1/O) devices, such as a keyboard, a mouse, touchscreen and/or a video display. The information handling system may also include one or more virtual or physical buses operable to transmit communications between the various hardware and/or software components.

An information handling system may aggregate the semantic cryptographic fingerprint and the system context data to create a hash that may be used to ensure the authenticity of the content by other devices. In some embodiments, the information handling system may have a sensor such as a microphone. In some embodiments, the microphone record the sounds of a thunderstorm. In some embodiments, the sensor will have a private key that it may sign to the recording. In some embodiments, the information handling system may use a fingerprint algorithm to create a semantic cryptographic fingerprint. In some embodiments, the semantic cryptographic fingerprint may be created using non-reversable fingerprint algorithm. In some embodiments, the information handling system may create the semantic cryptographic fingerprint before the recording is stored to memory accessible by the user. In some embodiments, the information handling system may determine the system context data. In some embodiments, the system context data may include information, such as, but not limited to, date and time as well as the location the recording was made, along with any other metadata of the recording. In some embodiments, the information handling system may create a hash comprising the semantic cryptographic fingerprint and the system context data. In some embodiments, the hash may be signed with a private key. In some embodiments, the hash and an indicator of the content may be stored in a private as well as a public database. In some embodiments, the information handling system may limit access of content to the information handling system based on the hash of the content. For example, in some embodiments, a user may want to post the recording to a social media site. The application may only allow the recording to be posted if the hash from the recording is determined to be same, or nearly the same, as the hash stored in the private or public database. In this way, the application may ensure, only an unadulterated recording has been posted.

In some embodiments, cryptographic modules, provisioned with credentials during development or manufacturing, within each sensor element within a consumer electronic device, such as within the camera sensor, microphones, and keyboard controller may be used as a basis for automatic computation of a cryptographic hash before the user has the ability to manipulate the content, since the computation of the hash. In some embodiments, this module may create a robust digital fingerprint from the data captured within the analog-digital converter element of the sensor at relevant intervals, append relevant metadata such as GPS location, date, and time, and may sign it with the provisioned private cryptographic key credential unique to the sensor creating a unique cryptographic hash. In some embodiments, this private-key signed cryptographic hash may be uploaded anonymously and contemporaneously to a publicly viewable database or ledger. In some embodiments, the upload may create a publicly auditable record of data creation tied to the specific sensor and device that originated it (the public portion of the original provisioned credential). In some embodiments, if data originating from this device needs to be verified/attested to establish evidentiary quality or reliability, the data “frames” concerning the relevant information can be compared to the fingerprints contemporaneously published on the public database to ensure the date, time, location, and originating device are correct, and that the information has not been materially altered.

### III. Methods of the Disclosure

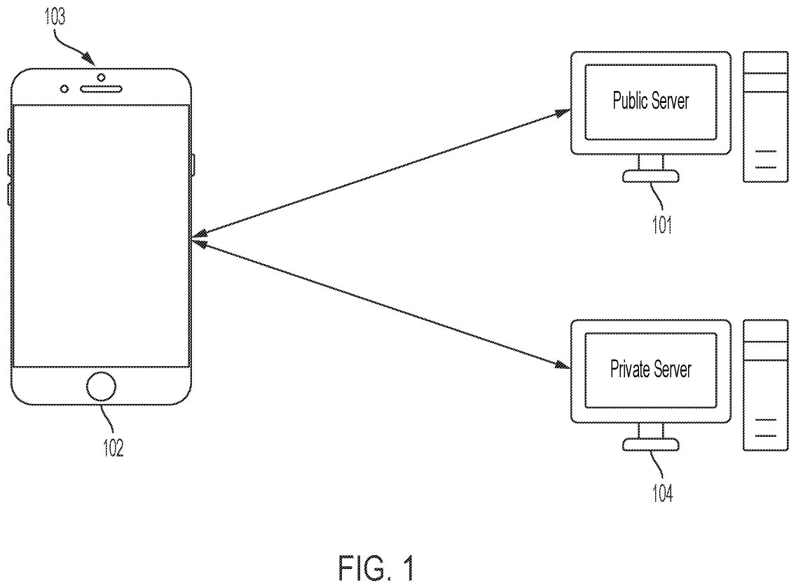

A method for creating multimodal semantic sensor data fingerprinting may include using information collected from a variety of information handling systems. Information handling systems may be used in numerous different environments with a plethora of different sensors. Input sensors of an information handling system may collect data about an environment in which an information handling system is being used as shown in FIG. 1. One or more input sensors 103 of an information handling system 102 may sense characteristics of an environment of the information handling system 102 thereby generating capture content. In some embodiments, non-limiting examples of such input sensors 103 may comprise a camera, a microphone, a thermometer, an accelerometer, a pressure gauge, a chemical detection gauge, a humidity gauge, etc. In some embodiments, non-limiting examples of an information handling system 102 comprise smart phone, tablet, computer, digital camera, computer server, etc. After the input sensor 103 generates the captured content, the information handling system 102 determines a hash of the semantic cryptographic fingerprint and the system context. The hash may then be stored in database or directory on a public 101 or private 104 server. In some embodiments, non-limiting examples of such a public server 101 may be maintained by governmental organization, social media entities, trade associations, internet associations, etc. and may accessed by any entity. In some embodiments, non-limiting examples of such a private server 104 may be maintained by sensor manufacturers, technology companies, social media entities, etc. and may be accessed only by authorized entities.

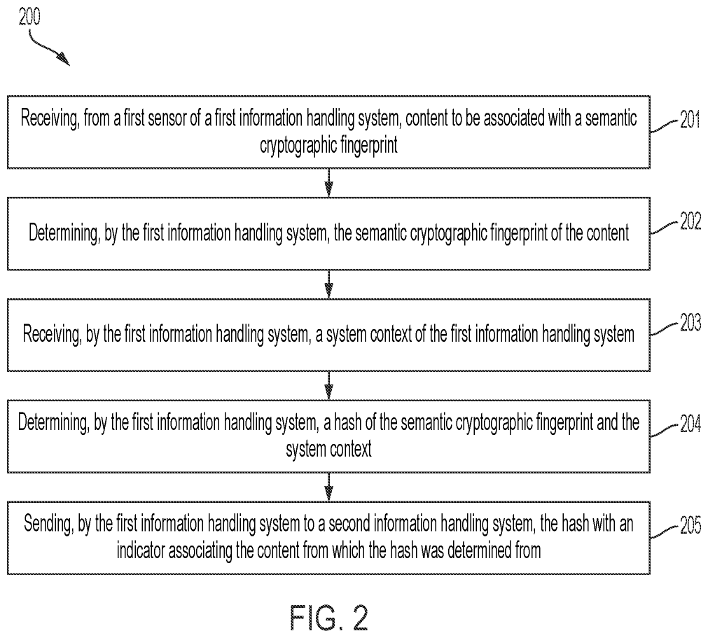

FIG. 2 is a flowchart illustrating an example method for cryptographic hash creation and management for an information handling system. Aspects of the method 200 can be executed by the first information handling system 102 of FIG. 1 and/or other suitable means for performing the steps. In some embodiments, non-limiting examples of an information handling system comprise smart phone, tablet, computer, digital camera, computer server, etc. As illustrated, the method 200 includes a number of enumerated steps, but aspects of the method 200 may include additional steps before, after, and in between the enumerated steps. In some embodiments, one or more of the enumerated steps may be omitted or performed in a different order.

At block 201, in some embodiments, the first input sensor 103 of FIG. 1 of a first information handling system 102 of FIG. 1 receives content to be associated with a semantic cryptographic fingerprint. In some embodiments, non-limiting examples of the input sensor 103 of FIG. 1 of the first information handling system 102 of FIG. 1 may comprise a camera, a microphone, a thermometer, an accelerometer, pressure gauge, chemical detection gauge, humidity gauge, etc., each of which may generate corresponding content (e.g., image data, audio data, temperature data, acceleration data, pressure data, chemical concentration data, humidity data, etc.).

At block 202, in some embodiments, the first information handling system 102 of FIG. 1, determines the semantic cryptographic fingerprint of the content. In one non-limiting example of the input sensor 103 of FIG. 1 includes a camera that is connected to an information handling system 102 of FIG. 1 of which a non-limiting example is a smart phone. In some embodiments, the smart phone may determine the semantic cryptographic fingerprint after the photograph is captured by the camera present on the smart phone. In some embodiments, the semantic cryptographic fingerprint is created using a fingerprinting algorithm that models key features in the sensor data. In some embodiments, the fingerprinting algorithm may comprise signing the input sensor-captured content with a private key that is unique to the sensor, passing the signed captured content to a DataFrame Composer that buffers multiple sensor-captured content data streams according to preset policies, outputting one or more non-reversible semantic cryptographic fingerprint. Semantic fingerprinting algorithms may be suited to the type of data produced by the sensor or human interface device. For example, a keyboard input device may utilize a text embedding model common in the art, or other statistical measurements of the text distribution such as word frequency, character frequency, punctation frequency, and any other features useful in programmatically distinguishing a given text passage from other similar passages, without retaining the actual text inputs for reasons of privacy. In another example, a camera sensor may employ a sparse feature embedding of key visual features, which would return a numerical series of activations that would be similarly activated if the algorithm would be applied to the same image or an image with nearly identical visual features. If the image were to be materially modified, such as replacing the face of a person with another, the feature activations would be affected and show a divergence from the original image. A threshold value can be determined per application that dictates how structurally similar the two images are permitted to be in order for the candidate image to be considered a faithful representation of the original. In another example, an audio sensor may employ a similar approach to the technique used for images, but where the features are computed for an audio spectrogram representing the time and frequency dimensions of the audio data. Or, a dimensional compression may be utilized that flattens the frequency domain into a single vector or sparse set of vectors, useful for verifying but not reconstructing the candidate signal. In either approach, the insertion, deletion, or replacement of a spoken word or sound would cause the computed features to deviate significantly at the time steps the edit occurred.

At block 203, in some embodiments, the first information handling system 102 of FIG. 1, receives a system context of the first information handling system 102 of FIG. 1. In some embodiments, the system context of the first information handling system 102 of FIG. 1 may comprise a date and time, a location, a login name of the user, or other system data of the information handling 102 of FIG. 1 recorded at the time of the capture by the input sensor 103 of FIG. 1.

At block 204, in some embodiments, the first information handling system 102 of FIG. 1, determines a hash of the semantic cryptographic fingerprint and the system context. In some embodiments, a hashing algorithm is used to create the hash. In some embodiments, the hashing algorithm takes both semantic cryptographic fingerprint and the system context as inputs and outputs a unique hash. Examples of hashing algorithms include RIPEMD-160, SHA-256, and SHA-512. Hashing algorithms operate on generic binary data and as such are not sensitive to the underlying data type. The data-type optimization will occur prior to hash computation i.e. during the dataframe packing stage, which will determine how much data to bundle into each packet to make a reasonable tradeoff between specificity (i.e. 20 seconds of audio vs 10 minutes of audio as one non-limiting example) and practical bandwidth for the application. New hashing algorithms can be utilized as they become available. The key requirement is that whatever algorithm used to create the hash must be identified on the dataframe and widely accessible so that dataframes can be readily verified at any point in the future.

At block 205, in some embodiments, the first information handling system 102 of FIG. 1 sends to a second information handling system the hash with an indicator of the content from which the hash was determined from. In some embodiments, a non-limiting example of the second information handling system may be a private and/or public server 101, 104 of FIG. 1. In some embodiments, the content is transmitted with the hash, such as when the hash and the content indicator are stored in a database or directory stored in the memory of the private and/or public server 101, 104 of FIG. 1.

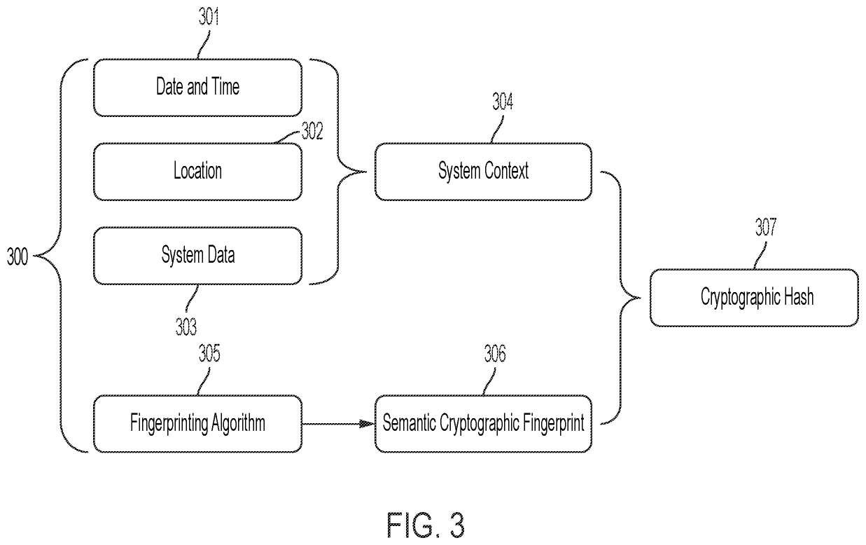

FIG. 3 is a flow chart further illustrating an example method 300 of how a cryptographic hash is computed. In some embodiments, captured content of an input sensor 103 of FIG. 1 may be submitted to a fingerprinting algorithm 305. In some embodiments, the output of the fingerprinting algorithm is a semantic cryptographic fingerprint 306. In some embodiments, the information handling system 102 of FIG. 1 with the input sensor 103 of FIG. 1 may have also recorded the date and time 301, location 302, and system data 303 associated with the captured content. In some embodiments the location data may comprise geolocation data from GPS, address location from local area networks, etc. In some embodiments, system data may comprise the mac address and other cached data of the first information handling system 101 of FIG. 1. In some embodiments, this data is aggregated into a system context 304. The system context 304 is then appended to the semantic cryptographic fingerprint 306 via the hashing algorithm creating a cryptographic hash 307 output.

One non-limiting example includes a situation where digital video evidence is at issue in a criminal legal proceeding, and it may weigh heavily as to the guilt or innocence of the accused. In some embodiments, if the digital video captured from a camera (i.e. the input sensor 103 of FIG. 1) was captured via the system described in this disclosure, the semantic cryptographic fingerprint 306 that gives rise to the cryptographic hash 307 of the presented evidence, captured using the same methodology, as described at least in FIGS. 2 and 3, could be compared to the cryptographic hash 307 published to the database of a public server 103 of FIG. 1 contemporaneously with the time of capture; thus, verifying that: (i) the video was captured at the stated place and time, as the published system context 304 suggests; (ii) the content of the video frames has not been materially altered, which is confirmed by the hash 307; (iii) the video was not generated or produced after the fact, as the database stored in the memory of the public server 103 of FIG. 1 was updated contemporaneously to the moment of capture.

One non-limiting example includes a situation where two authors of intellectual property are in dispute about who first documented a certain invention, based on competing sets of digital documents describing the new claims. In some embodiments, if the intellectual property was produced via the system described in this disclosure, the sequence of text read by the keyboard (i.e. the input sensor 103 of FIG. 1) at the time of original authorship could be verified based on the contemporaneously published cryptographic hash 307 developed from the semantic cryptographic fingerprint 306 and the system context 304, allowing a precise, publicly recorded reference for the time of original authorship. Without such a system, it may be impossible to adjudicate the rightful owner where the invention documentation was performed with an information handling system.

One non-limiting example includes a situation where a photograph generated from a camera (i.e. the input sensor 103 of FIG. 1) is provided to media outlets that appears to show a politician engaging in illegal or objectionable conduct. In some embodiments, a media outlet could search the database stored in the memory of a public server 103 FIG. 1 for a cryptographic hash 307 developed from the semantic cryptographic fingerprint 306 and system context 304 matching that of the purported image, and if none were found, they could assume the image untrustworthy and likely a forgery, and avoid amplifying misinformation to the public. Such events will be increasingly common with the advancement of image, video, and audio generation and manipulation tools, and even if eventually proven false, the damage to the public discourse caused by the original reporting can never be fully reversed.

One non-limiting example includes a situation where a malicious actor generates a fabricated audio and video recording of a company financial officer, along with fabricated financial data, and publishes it to social media platforms, hoping to profit from a subsequent move in the price of the company's stock. In some embodiments, under the scheme described in this disclosure, because there would be no cryptographic hash 307 developed from the semantic cryptographic fingerprint 306 and the system context 304 stored in the memory of a database on a public server 103 in FIG. 1 tying these fabricated artifacts to either a recognized company or a device, they may be labeled as likely fraudulent and removed from amplification systems to avoid the spread of false information, and thwarting the malicious actor's misdeeds.

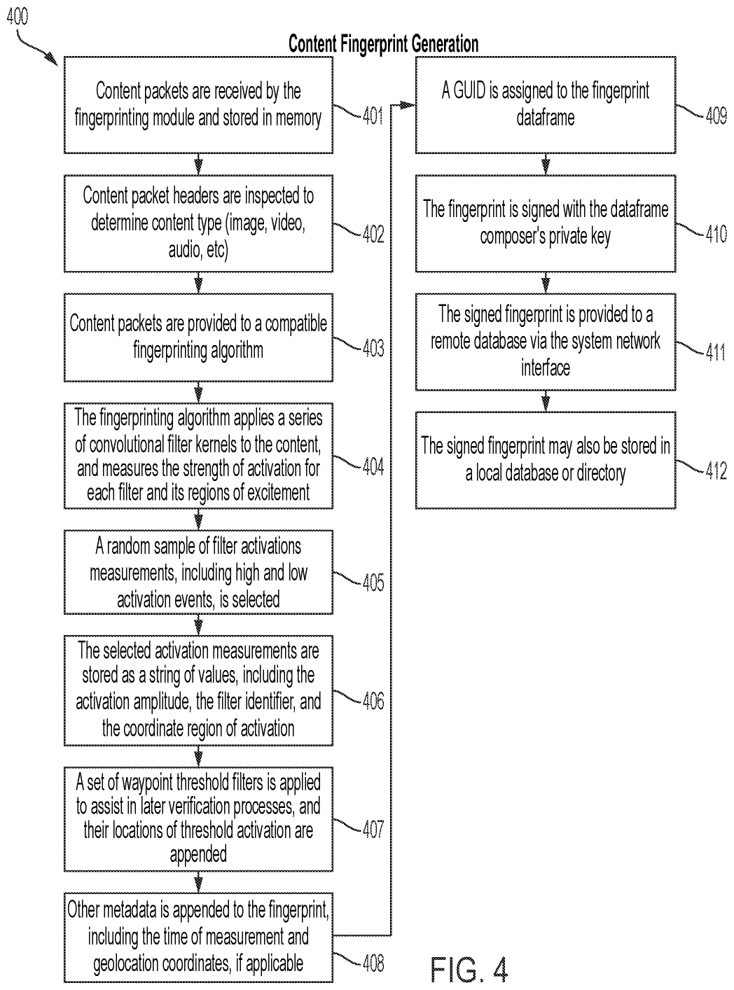

FIG. 4 is a flowchart illustrating an example method for content fingerprint creation and management for an information handling system. Aspects of the method 400 can be executed by the first information handling systems 102 of FIG. 1 and/or other suitable means for performing the steps. As illustrated, the method 400 includes a number of enumerated steps, but aspects of the method 400 may include additional steps before, after, and in between the enumerated steps. In some embodiments, one or more of the enumerated steps may be omitted or performed in a different order.

Referring to FIG. 2, content is received and a semantic cryptographic fingerprint is determined at blocks 201 and 202, respectively. Blocks 401-407 of FIG. 4 are one non-limiting example of performing blocks 201 and 202. At block 401, in some embodiments, content packets are received by the fingerprinting module and stored in memory. One non-limiting example of this is, the semantic cryptographic fingerprinting module of a tablet will receive the captured content by the sensor and place it in memory not accessible to the user.

At block 402, in some embodiments, content packet headers are inspected to determine content type (image, video, audio, etc.) One non-limiting example is the tablet inspecting the content packet headers of the information captured by the sensor. In some embodiments the tablet may determine that the captured content is one or more of the following: picture, video, audio, etc.

At block 403, in some embodiments, content packets are provided to a compatible fingerprinting algorithm. In some embodiments, the tablet will have one of several fingerprinting algorithms. In some embodiments, the tablets will provide the content to the fingerprinting algorithm designated for that captured content. One non-limiting example of this would be, that an image captured from the camera of a tablet will be provided to the fingerprinting algorithm designated for pictures.

At block 404, in some embodiments, the fingerprinting algorithm applies a series of statistical modeling processes such as convolutional filter kernels to the content, and measures the strength of activation for each filter and its regions of excitement. At block 405, in some embodiments, a random sample of filter activations measurements, including high and low activation events, is selected. At block 406, in some embodiments, the selected activation measurements are stored as a string of values, including the activation amplitude, the filter identifier, and the coordinate region of activation. At block 407, in some embodiments, a set of waypoint threshold filters is applied to assist in later verification processes, and their locations of threshold activation are appended.

Referring to FIG. 2, the system context received at block 203 may correspond to the system context received at block 408 of FIG. 4. At block 408, in some embodiments, other metadata is appended to the fingerprint, including the time of measurement and geolocation coordinates, if applicable.

At block 409, in some embodiments, a globally unique identifier is assigned to the fingerprint data frame. In some embodiments, the tablet may create a unique identifier based on the unique fingerprint and other metadata.

Referring to FIG. 2, the determined hash at block 204 may be a signed version of the fingerprint and the system context as determined at block 410 of FIG. 4. At block 410, in some embodiments, the fingerprint is signed with the data frame composer's private key. In some embodiments, the tablet may sign the fingerprint with a private key.

Referring to FIG. 2, the transmission of block 205 may include the information provided at blocks 411 and/or 412 of FIG. 4. At block 411, in some embodiments, the signed fingerprint is provided to a remote database via the system network interface. In some embodiments, the tablet may use a wireless or terrestrial means to provide the signed fingerprint to a database. In some embodiments, such network interfaces may include, but are not limited to Wireless Local Area Networks, Bluetooth, Cellar, Satellite, Wide Area Network, Fiber, Broadband, Cable, DSL, etc. At block 412, in some embodiments, the singed fingerprint may also be stored in a local database or directory. In some embodiments, the local database or directory may be stored in the memory of a private computer, server, or other storage device.

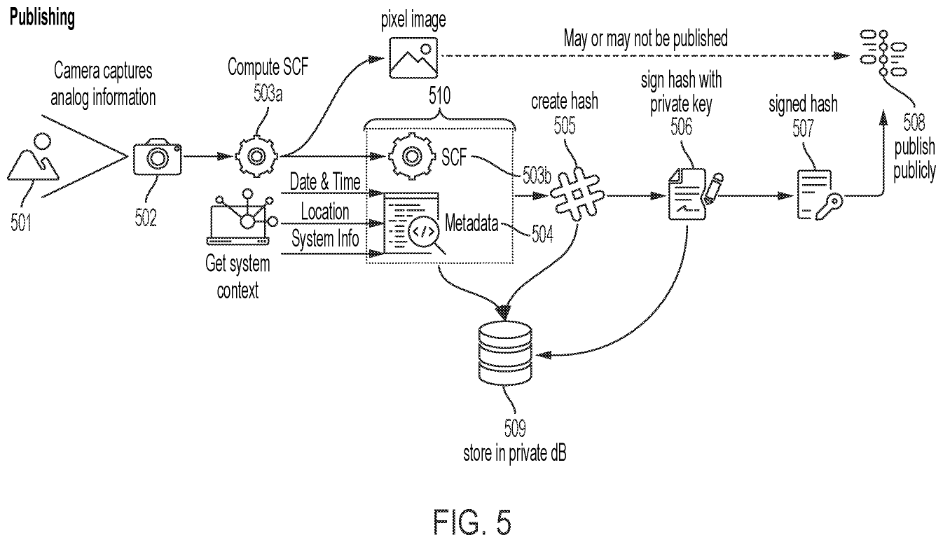

FIG. 5 is a block diagram showing how in some embodiments, an image is captured, provided with a cryptographic hash developed from the semantic fingerprint and system context of the captured image, and published. In some embodiments, an input sensor 103 of FIG. 1 which may comprise a camera, a microphone, a thermometer, an accelerometer, a pressure gauge, a chemical detection gauge, a humidity gauge, etc. In some embodiments, a camera 502 may generate captured content 501 (i.e. take a picture.) In some embodiments, a non-limiting example includes a microphone that may capture sounds generated by individuals, such as their voice, movement of objects or other sounds. In some embodiments, a non-limiting example of a collection of sensors may comprise a thermometer, vibrational gauge, force gauge, piezo gauge, humidity gauge, etc. for capturing data regarding various aspects of an environment around the information handling system.

In some embodiments, the camera 502, acting as an information handling system, may then compute the semantic cryptographic fingerprint 503. In some embodiments, the camera 502 may record the date and time, location, and the system info as metadata 504. In some embodiments the location data may comprise geolocation data from GPS, address location from local networks, etc. In some embodiments, system data may comprise the mac address and other cached data of the first information handling system 101 of FIG. 1. In some embodiments, the camera 502 or another information handling system, may create a cryptographic hash 505 from the metadata 504 and the semantic cryptographic fingerprint 503. In some embodiments, the determination of the cryptographic hash 505 is completed before the user or system applications may access or manipulate the content. In some embodiments, the cryptographic hash 505 may be stored in a private database 509. In some embodiments the cryptographic hash 505 is signed with a private key 506 creating a signed hash 507. The signed hash 507 is then published in a public database or directory 508.

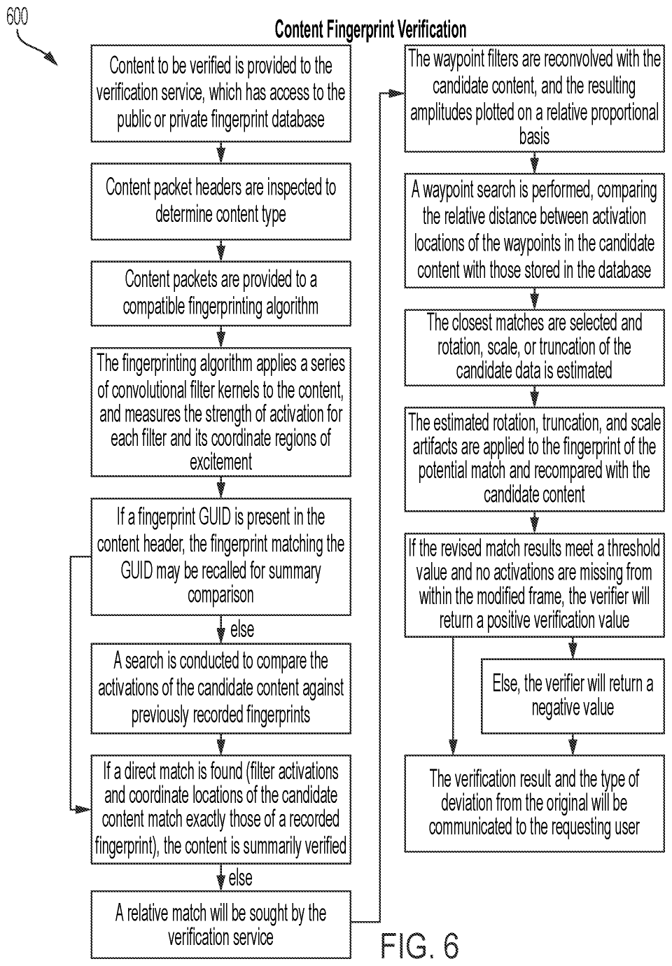

FIG. 6 is a detailed block diagram of content fingerprint verification according to some embodiments of the disclosure. Aspects of the method 600 can be executed by the first 102 of FIG. 1 and/or other suitable means for performing the steps. As illustrated, the method 600 includes a number of enumerated steps, but aspects of the method 600 may include additional steps before, after, and in between the enumerated steps. In some embodiments, one or more of the enumerated steps may be omitted or performed in a different order.

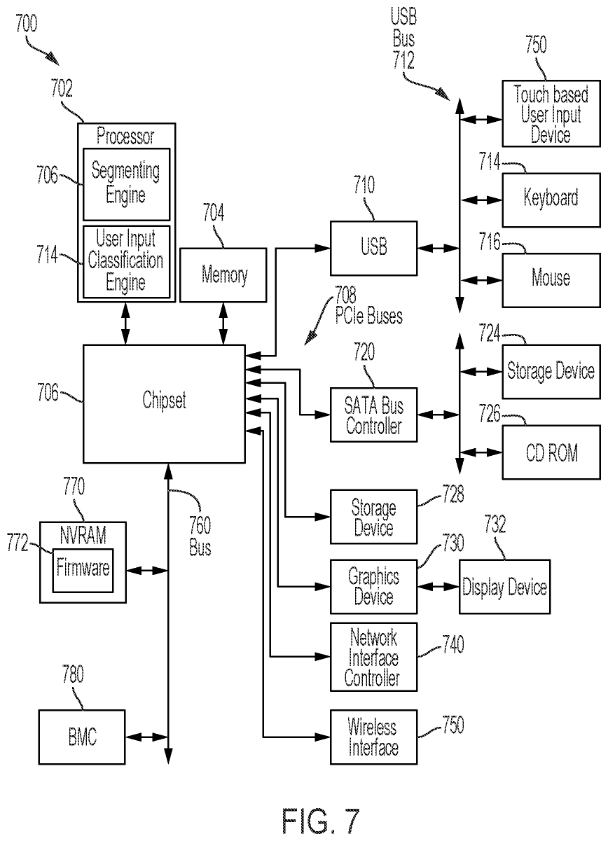

FIG. 7 illustrates an example information handling system 700. Information handling system 700 may include a processor 702 (e.g., a central processing unit (CPU)), a memory (e.g., a dynamic random-access memory (DRAM)) 704, and a chipset 706. In some embodiments, one or more of the processor 702, the memory 704, and the chipset 706 may be included on a motherboard (also referred to as a mainboard), which is a printed circuit board (PCB) with embedded conductors organized as transmission lines between the processor 702, the memory 704, the chipset 706, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 702, the memory 704, the chipset 706, and/or other components may be organized as a System on Chip (SoC).

The processor 702 may execute program code by accessing instructions loaded into memory 704 from a storage device, executing the instructions to operate on data also loaded into memory 704 from a storage device, and generate output data that is stored back into memory 704 or sent to another component. The processor 702 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 702 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 706 may facilitate the transfer of data between the processor 702, the memory 704, and other components. In some embodiments, chipset 706 may include two or more integrated circuits (ICs), such as a northbridge controller coupled to the processor 702, the memory 704, and a southbridge controller, with the southbridge controller coupled to the other components such as USB 710, SATA 720, and PCie buses 708. The chipset 706 may couple to other components through one or more PCIe buses 708.

Some components may be coupled to one bus line of the PCIe buses 708, whereas some components may be coupled to more than one bus line of the PCIe buses 708. One example component is a universal serial bus (USB) controller 710, which interfaces the chipset 706 to a USB bus 712. A USB bus 712 may couple input/output components such as a keyboard 714 and a mouse 716, but also other components such as USB flash drives, or another information handling system. Another example component is a SATA bus controller 720, which couples the chipset 706 to a SATA bus 722. The SATA bus 722 may facilitate efficient transfer of data between the chipset 706 and components coupled to the chipset 706 and a storage device 724 (e.g., a hard disk drive (HDD) or solid-state disk drive (SDD)) and/or a compact disc read-only memory (CD-ROM) 726. The PCIe bus 708 may also couple the chipset 706 directly to a storage device 728 (e.g., a solid-state disk drive (SDD)). A further example of an example component is a graphics device 730 (e.g., a graphics processing unit (GPU)) for generating output to a display device 732, a network interface controller (NIC) 740, and/or a wireless interface 750 (e.g., a wireless local area network (WLAN) or wireless wide area network (WW AN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces). In some embodiments, chipset 706 may be directly connected to an individual end point via a PCIe root port within the chipset and a point-to-point topology as shown in FIG. 7.

The chipset 706 may also be coupled to a serial peripheral interface (SPI) and/or Inter-Integrated Circuit (I2C) bus 760, which couples the chipset 706 to system management components. For example, a non-volatile random-access memory (NVRAM) 770 for storing firmware 772 may be coupled to the bus 760. As another example, a controller, such as a baseboard management controller (BMC) 780, may be coupled to the chipset 706 through the bus 760. BMC 780 may be referred to as a service processor or embedded controller (EC). Capabilities and functions provided by BMC 780 may vary considerably based on the type of information handling system. For example, the term baseboard management system may be used to describe an embedded processor included at a server, while an embedded controller may be found in a consumer-level device. As disclosed herein, BMC 780 represents a processing device different from processor 702, which provides various management functions for information handling system 700. For example, an embedded controller may be responsible for power management, cooling management, and the like. An embedded controller included at a data storage system may be referred to as a storage enclosure processor or a chassis processor.

Information handling system 700 may include additional processors that are configured to provide localized or specific control functions, such as a battery management controller. Bus 760 can include one or more busses, including a Serial Peripheral Interface (SPI) bus, an Inter-Integrated Circuit (I2C) bus, a system management bus (SMBUS), a power management bus (PMBUS), or the like. BMC 780 may be configured to provide out-of-band access to devices at information handling system 700. Out-of-band access in the context of the bus 760 may refer to operations performed prior to execution of firmware 772 by processor 702 to initialize operation of system 700.

Firmware 772 may include instructions executable by processor 702 to initialize and test the hardware components of system 700. For example, the instructions may cause the processor 702 to execute a power-on self-test (POST). The instructions may further cause the processor 702 to load a boot loader or an operating system (OS) from a mass storage device. Firmware 772 additionally may provide an abstraction layer for the hardware, such as a consistent way for application programs and operating systems to interact with the keyboard, display, and other input/output devices. When power is first applied to information handling system 700, the system may begin a sequence of initialization procedures, such as a boot procedure or a secure boot procedure. During the initialization sequence, also referred to as a boot sequence, components of system 700 may be configured and enabled for operation and device drivers may be installed. Device drivers may provide an interface through which other components of the system 700 can communicate with a corresponding device. The firmware 772 may include a basic input-output system (BIOS) and/or include a unified extensible firmware interface (UEFI). Firmware 772 may also include one or more firmware modules of the information handling system. Additionally, configuration settings for the firmware 772 and firmware of the information handling system 700 may be stored in the NVRAM 770. NVRAM 770 may, for example, be a non-volatile firmware memory of the information handling system 700 and may store a firmware memory map namespace 700 of the information handling system. NVRAM 770 may further store one or more container-specific firmware memory map namespaces for one or more containers concurrently executed by the information handling system.

Information handling system 700 may include additional components and additional busses, not shown for clarity. For example, system 700 may include multiple processor cores (either within processor 702 or separately coupled to the chipset 706 or through the PCIe buses 708), audio devices (such as may be coupled to the chipset 706 through one of the PCIe busses 708), or the like. While a particular arrangement of bus technologies and interconnections is illustrated for the purpose of example, one of skill will appreciate that the techniques disclosed herein are applicable to other system architectures. Information handling system 700 may include multiple processors and/or redundant bus controllers. In some embodiments, one or more components may be integrated together in an integrated circuit (IC), which is circuitry built on a common substrate. For example, portions of chipset 706 can be integrated within processor 702. Additional components of information handling system 700 may include one or more storage devices that may store machine-executable code, one or more communications ports for communicating with external devices, and various input and output (1/O) devices, such as a keyboard, a mouse, and a video display.

In some embodiments, processor 702 may include multiple processors, such as multiple processing cores for parallel processing by the information handling system 700. For example, the information handling system 700 may include a server comprising multiple processors for parallel processing. In some embodiments, the information handling system 700 may support virtual machine (VM) operation, with multiple virtualized instances of one or more operating systems executed in parallel by the information handling system 700. For example, resources, such as processors or processing cores of the information handling system may be assigned to multiple containerized instances of one or more operating systems of the information handling system 700 executed in parallel. A container may, for example, be a virtual machine executed by the information handling system 700 for execution of an instance of an operating system by the information handling system 700. Thus, for example, multiple users may remotely connect to the information handling system 700, such as in a cloud computing configuration, to utilize resources of the information handling system 700, such as memory, processors, and other hardware, firmware, and software capabilities of the information handling system 700. Parallel execution of multiple containers by the information handling system 700 may allow the information handling system 700 to execute tasks for multiple users in parallel secure virtual environments. For example, parallel execution of services described herein may occur in parallel virtualized containers.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method comprising:
receiving, from a first sensor of a first information handling system, content to be associated with a semantic cryptographic fingerprint;
determining, by the first information handling system, the semantic cryptographic fingerprint of the content;
receiving, by the first information handling system, a system context of the first information handling system;
determining, by the first information handling system, a hash of the semantic cryptographic fingerprint and the system context; and
sending, by the first information handling system to a second information handling system, the hash with an indicator associating the content from which the hash was determined from.

2. The method of claim 1, wherein the first sensor may comprise a camera, a microphone, or another measuring device.

3. The method of claim 2, wherein the content is signed with a private key of the first sensor.

4. The method of claim 1, wherein the semantic cryptographic fingerprint is nonreversible.

5. The method of claim 1, wherein the first information handling system create the semantic cryptographic fingerprint before storing the semantic cryptographic fingerprint with the content in a user-accessible region of memory.

6. The method of claim 3, wherein a fingerprint algorithm comprises applying a series of statistical modeling processes to create the semantic cryptographic fingerprint.

7. The method of claim 1, wherein the system context comprises a sensor measurement date, timing, a geolocation coordinate, metadata, private key of the first sensor.

8. The method of claim 1, wherein the hash, associated with a private key, is uploaded to a public database with an associated public key.

9. The method of claim 1, wherein the first or a third information handling system, sends an instruction to an application present on the first or third information handling system that limits access to the content to a set of users based on the hash of the content.

10. An information handling system, comprising:
a processor;
a memory;
wherein the processor is configured to perform steps comprising:
receiving, from a first sensor of a first information handling system, content to be associated with a semantic cryptographic fingerprint;
determining, by the first information handling system, the semantic cryptographic fingerprint of the content;
receiving, by the first information handling system, a system context of the first information handling system;
determining, by the first information handling system, a hash of the semantic cryptographic fingerprint and the system context; and
sending, by the first information handling system to a second information handling system, the hash with an indicator associating the content from which the hash was determined from.

11. The system of claim 10, wherein the first sensor may comprise a camera, a microphone, or another measuring device.

12. The system of claim 11, wherein the content is signed with a private key of the first sensor.

13. The system of claim 10, wherein the semantic cryptographic fingerprint is nonreversible.

14. The system of claim 10, wherein the first information handling system create the semantic cryptographic fingerprint before storing the semantic cryptographic fingerprint with the content in a user-accessible region of memory.

15. The system of claim 12, wherein a fingerprint algorithm comprises applying a series of statistical modeling processes to create the semantic cryptographic fingerprint.

16. The system of claim 10, wherein the system context comprises a sensor measurement date, timing, a geolocation coordinate, metadata, private key of the first sensor.

17. The system of claim 10, wherein the hash, associated with a private key, is uploaded to a public database with an associated public key.

18. The system of claim 10, wherein the first or a third information handling system, sends an instruction to an application present on the first or third information handling system that limits access to the content to a set of users based on the hash of the content.

19. A computer program product comprising:
a non-transitory computer readable medium comprising instructions for causing an information handling system to perform steps comprising:
receiving, from a first sensor of a first information handling system, content to be associated with a semantic cryptographic fingerprint;
determining, by the first information handling system, the semantic cryptographic fingerprint of the content;
receiving, by the first information handling system, a system context of the first information handling system; and
determining, by the first information handling system, a hash of the semantic cryptographic fingerprint and the system context;
sending, by the first information handling system to a second information handling system, the hash with an indicator associating the content from which the hash was determined from.

20. The system of claim 19, wherein the first information handling system create the semantic cryptographic fingerprint before storing the semantic cryptographic fingerprint with the content in a user-accessible region of memory.
